(19) United States
(12) Patent Application Publication
(10) Pub. No.: US 2020/0141755 A1
(43) Pub. Date: May 7, 2020

(54) NAVIGATION PROCESSING METHOD, APPARATUS, AND CONTROL DEVICE

(71) Applicant: SZ DJI TECHNOLOGY CO., LTD., Shenzhen (CN)

(72) Inventors: Guanhua SU, Shenzhen (CN); Cheng ZOU, Shenzhen (CN); Shuyuan MAO, Shenzhen (CN); Xiao HU, Shenzhen (CN); Zhuo GUO, Shenzhen (CN); Baojie MIAO, Shenzhen (CN)

(21) Appl. No.: 16/690,838

(22) Filed: Nov. 21, 2019

Related U.S. Application Data
(63) Continuation of application No. PCT/CN2017/085794, filed on May 24, 2017.

(51) Int. Cl. G01C 21/36; G05D 1/00; G05D 1/08; G06F 3/0481; B64C 39/02

(52) U.S. Cl. CPC G01C 21/3632; G05D 1/0016; B64C 2201/146; G06F 3/04817; B64C 39/024; G05D 1/085

(57) ABSTRACT

A navigation processing method includes displaying an image at a graphical user interface. The image is obtained by an imaging device provided at a movable object. The method also includes determining, in response to receiving a location selection operation at the graphical user interface, location information of a location point selected by the location selection operation in the image. The method further includes controlling the movable object to move toward a target navigation point, the target navigation point being obtained based on the location information.

### CROSS-REFERENCE TO RELATED APPLICATION

This application is a continuation application of International Application No. PCT/CN2017/085794, filed on May 24, 2017, the entire content of which is incorporated herein by reference.

### TECHNICAL FIELD

The present disclosure relates to the technology field of navigation applications and, more particularly, to navigation processing method, apparatus, and control device.

### BACKGROUND

Aircrafts, particularly unmanned aerial vehicles (“UAVs”) that can be remotely controlled, can effectively assist people in performing tasks. Devices carried by the UAVs, such as imaging devices and agriculture spraying devices, can complete various tasks in an excellent manner, such as aerial photographing, rescue, survey, power line inspection, agriculture spraying, and patrol and investigation, etc.

In generally, a UAV can automatically plan its flight course, and can fly on navigation based on the flight course. In conventional flight on navigation, a user has to specify points on a map to determine locations of flight points. The UAV then navigates based on the locations of the flight points, to perform an automatic flight to execute corresponding tasks.

In conventional technologies, the user can only determine locations of the flight points on the map. However, in general, map data have errors. The locations of the flight points determined by the user on the map may have a relatively far distance from the locations of the objects the user desires to observe. This may seriously affect the accuracy of the UAV executing the corresponding flight tasks.

### SUMMARY

In accordance with an aspect of the present disclosure, there is provided a navigation processing method. The method includes displaying an image at a graphical user interface. The image is obtained by an imaging device provided at a movable object. The method also includes determining, in response to receiving a location selection operation at the graphical user interface, location information of a location point selected by the location selection operation in the image. The method further includes controlling the movable object to move toward a target navigation point, the target navigation point being obtained based on the location information.

In accordance with another aspect of the present disclosure, there is provided a control device. The control device includes a storage device configured to store program instructions and a processor configured to retrieve and execute the program instructions stored in the storage device to display an image at a graphical user interface, the image being obtained by an imaging device provided at a movable object. The processor is also configured to retrieve and execute the program instructions stored in the storage device to determine, in response to receiving a location selection operation at the graphical user interface, location information of a location point selected by the location selection operation in the image. The processor is further configured to retrieve and execute the program instructions stored in the storage device to control the movable object to move toward a target navigation point, the target navigation point being obtained based on the location information.

The technical solutions of the present disclosure make it convenient for a user to determine a location point based on an image captured by the UAV to realize navigation for a movable object. The user may intuitively perform a pointing navigation operation on a graphical user interface, to cause the movable object to directly move toward a location where a target object can be effectively observed. The technical solutions improve the accuracy of the movable object executing relevant observation tasks, and increase the efficiency of task execution.

### BRIEF DESCRIPTION OF THE DRAWINGS

To better describe the technical solutions of the various embodiments of the present disclosure, the accompanying drawings showing the various embodiments will be briefly described. As a person of ordinary skill in the art would appreciate, the drawings show only some embodiments of the present disclosure. Without departing from the scope of the present disclosure, those having ordinary skills in the art could derive other embodiments and drawings based on the disclosed drawings without inventive efforts.

FIG. 1 is a schematic diagram of a navigation system, according to an example embodiment.

FIG. 2a is a schematic illustration of a graphical user interface, according to an example embodiment.

FIG. 2b is a schematic illustration of a graphical user interface, according to another example embodiment.

FIG. 2c is a schematic illustration of a graphical user interface, according to another example embodiment.

FIG. 3 is a flow chart illustrating a navigation processing method, according to an example embodiment.

FIG. 4 is a flow chart illustrating a navigation processing method, according to another example embodiment.

FIG. 5 is a schematic diagram of a navigation processing device, according to an example embodiment.

FIG. 6 is a schematic diagram of a control device, according to an example embodiment.

### DETAILED DESCRIPTION OF THE EMBODIMENTS

Technical solutions of the present disclosure will be described in detail with reference to the drawings, in which the same numbers refer to the same or similar elements unless otherwise specified. It will be appreciated that the described embodiments represent some, rather than all, of the embodiments of the present disclosure. Other embodiments conceived or derived by those having ordinary skills in the art based on the described embodiments without inventive efforts should fall within the scope of the present disclosure.

As used herein, when a first component (or unit, element, member, part, piece) is referred to as “coupled,” “mounted,” “fixed,” “secured” to or with a second component, it is intended that the first component may be directly coupled, mounted, fixed, or secured to or with the second component, or may be indirectly coupled, mounted, or fixed to or with the second component via another intermediate component. The terms “coupled,” “mounted,” “fixed,” and “secured” do not necessarily imply that a first component is permanently coupled with a second component. The first component may be detachably coupled with the second component when these terms are used. When a first component is referred to as “connected” to or with a second component, it is intended that the first component may be directly connected to or with the second component or may be indirectly connected to or with the second component via an intermediate component. The connection may include mechanical and/or electrical connections. The connection may be permanent or detachable. The electrical connection may be wired or wireless. When a first component is referred to as “disposed,” “located,” or “provided” on a second component, the first component may be directly disposed, located, or provided on the second component or may be indirectly disposed, located, or provided on the second component via an intermediate component. When a first component is referred to as “disposed,” “located,” or “provided” in a second component, the first component may be partially or entirely disposed, located, or provided in, inside, or within the second component. The terms “perpendicular,” “horizontal,” “vertical,” “left,” “right,” “up,” “upward,” “upwardly,” “down,” “downward,” “downwardly,” and similar expressions used herein are merely intended for describing relative positional relationship.

In addition, the singular forms “a,” “an,” and “the” are intended to include the plural forms as well, unless the context indicates otherwise. The terms “comprise,” “comprising,” “include,” and the like specify the presence of stated features, steps, operations, elements, and/or components but do not preclude the presence or addition of one or more other features, steps, operations, elements, components, and/or groups. The term “and/or” used herein includes any suitable combination of one or more related items listed. For example, A and/or B can mean A only, A and B, and B only. The symbol “/” means “or” between the related items separated by the symbol. The phrase “at least one of” A, B, or C encompasses all combinations of A, B, and C, such as A only, B only, C only, A and B, B and C, A and C, and A, B, and C. In this regard, A and/or B can mean at least one of A or B. The term “module” as used herein includes hardware components or devices, such as circuit, housing, sensor, connector, etc. The term “communicatively couple(d)” or “communicatively connect(ed)” indicates that related items are coupled or connected through a communication channel, such as a wired or wireless communication channel. The term “unit,” “sub-unit,” or “module” may encompass a hardware component, a software component, or a combination thereof. For example, a “unit,” “sub-unit,” or “module” may include a processor, a portion of a processor, an algorithm, a portion of an algorithm, a circuit, a portion of a circuit, etc.

Further, when an embodiment illustrated in a drawing shows a single element, it is understood that the embodiment may include a plurality of such elements. Likewise, when an embodiment illustrated in a drawing shows a plurality of such elements, it is understood that the embodiment may include only one such element. The number of elements illustrated in the drawing is for illustration purposes only, and should not be construed as limiting the scope of the embodiment. Moreover, unless otherwise noted, the embodiments shown in the drawings are not mutually exclusive, and they may be combined in any suitable manner. For example, elements shown in one embodiment but not another embodiment may nevertheless be included in the other embodiment.

Next, the embodiments of the present disclosure will be described in detail. Unless there is obvious conflict, the various embodiments or various features of various embodiments may be combined.

According to the method and device of the present disclosure, a location point may be specified through use operations such as clicking in an image transmitted through a first person view (“FPV”) image transmission, and location information of the location point in the image may be calculated. The location information in the image may be converted to obtain a target navigation point. Then, movable objects, such as aircrafts, unmanned vehicles, etc., may be controlled to move to the target navigation point corresponding to the location information. The location of the target navigation point may be determined based on the location information of the location in the image.

In a control device, based on a user's need, a control mode for controlling a movable object may be configured as a location pointing navigation mode and a direction pointing navigation mode. In the location pointing navigation mode, a user may click a location point on a graphical user interface of the control device. The control device may determine location information of the location point in an image displayed at the graphical user interface. The control device may transmit the location information to the movable object to control the movable object to move toward the target navigation point indicated by the location information. The target navigation point may be determined based on the location information. The location where the target navigation point is located may be the ultimate destination of the movement.

In the direction pointing navigation mode, the user may click a location point on the graphical user interface of the control device. The control device may determine location information of the location point in an image displayed at the graphical user interface. The control device may transmit the location information to the movable object to control the movable object to move in a target moving direction indicated by the location information. The target moving direction may be determined based on the location information. For example, if the location point clicked by the user is located at the right upper direction relative to the center point of the image, then the control device may control the movable object, such as an aircraft, to fly toward the upper right direction. No target navigation point may be specified as the ultimate destination of the movable object. As long as the user does not interrupt the movement of the movable object toward the target moving direction, the movable object may continue to move toward the target moving direction.

Movable objects, such as aircrafts, unmanned vehicles, may be provided with an imaging device. The imaging device may capture images in real time. The movable object may transmit parts or all of the captured images to the control device. The images may be regarded as the first person view images of the movable object. The control device may be provided with a touch screen to display the images captured by the imaging device. A communication may be established between the movable object and the control device to realize point-to-point communication based on the communication connection. The imaging device may transmit the captured images to the movable object through wired or wireless connections. For example, the imaging device may transmit the images to the movable object through short distance wireless communication technologies, such as Bluetooth, near field communication (“NFC”), etc. The movable object may forward the images to the control device through protocols such as WiFi protocol, software defined radio (“SDR”) protocol, or other self-defined protocol.

In some embodiments, the control device may be provided with a touch screen to display received images. In some embodiments, the received images may be displayed in a graphical user interface. A portion of the display region of the images displayed at the graphical user interface may have a grid icon displayed. When the user clicks to select a location point in a region covered by the grid icon, an augmented reality circular disk may be generated closely adjacent the selected location point. The augmented reality circular disk may be displayed at the graphical user interface as a location icon of the location point. The grid icon may be used to represent the ground.

In some embodiments, coordinate locations of the location point in a global coordinate system may be determined based on the location information of the selected location point in the image. The coordinate locations in the global coordinate system represent the detailed location of the target navigation point. When computing to obtain the target navigation point, the computation may be based on height information of the movable object (such as the aircraft), attitude information of a gimbal carried by the movable object, the field of view (“FOV”) angle of the imaging device carried by the gimbal of the movable object, and the location information of the movable object.

In some embodiments, the control device may transmit location information of the location point in the image selected by a user click to the movable object. The movable object may be configured to calculate the target navigation point of the location point in the global coordinate system. The movable object may transmit the coordinate locations corresponding to the target navigation point to the control device. After receiving the related information of the target navigation point, the control device may send a prompt indicating whether to fly toward the target navigation point. For example, the control device may display a “start” icon at the graphical user interface. If an operation responding to the prompt is detected from the user, such as a click of the “start” icon, the control device may control the movable object to move toward the target navigation point.

In some embodiments, the movable object may not transmit any information regarding the target navigation point to the control device. After transmitting the location information of the location point in the image selected by the user click, within a predetermined time period, the control device may directly send a prompt indicating whether to fly toward the target navigation point. If a user confirmation response is received, the control device may transmit a control command to the movable object. The movable object may move toward the computed target navigation point based on the control command.

In some embodiments, after computing to obtain the target navigation point, the movable object may send a notification message only for indicating whether to start moving to the control device. After receiving the notification message, the control device may send a prompt indicating whether to fly toward the target navigation point. If a confirmation response is received from the user, the control device may transmit a control command to the movable object. The movable object may move toward the computed target navigation point based on the control command.

In some embodiments, after obtaining the location information of the location point in the image selected by the user click, the control device may calculate related location information of the target navigation point. The control device may send a prompt indicating whether to fly toward the target navigation point. If a confirmation response is received from the user, the control device may transmit a control command carrying related location information of the target navigation point to the movable object to control the movable object to move toward the target navigation point.

In some embodiments, based on the need of tasks such as observation, based on new images captured by the movable object during the movement process, the user may again click on the image displayed at the graphical user interface to select a new location point. A new target navigation point may be determined based on location information of the new location point in the image. The movable object may be controlled to move toward the new target navigation point. In some embodiments, the user may control the movable object through operations completely without a joystick. Nor does the user need to perform navigation operations by specifying a point on a map. Instead, the user can realize the navigation purpose through location pointing on the image. Because in the image, image objects in front of the aircraft captured by the imaging device may be determined, the user may determine the navigation point completely based on the image objects. This enables the user to accurately monitor an object that needs to be observed. For example, when an image includes a power tower that needs to be observed, and when the user desires to observe the power tower, the user may intuitively click a location point in a region covered by a grid icon where the power tower is located. Through a series of computations, the target navigation point corresponding to the location point may be determined. The aircraft may be automatically controlled to move toward the target navigation point to accomplish the observation task of the power tower.

In some embodiments, when the imaging performances of the imaging device, such as the imaging distance and the pixel size are considered, navigation through point-specifying on a map and the location pointing navigation mode based on the image displayed at the graphical user interface may be combined. For example, a rough location point of the object to be observed may be determined on a map. When the aircraft flies to be within a predetermined range from the rough location point, navigation mode may be switched to the location pointing navigation mode of the present disclosure, to thereby more accurately determining the target navigation point to guide the navigation of the movable object.

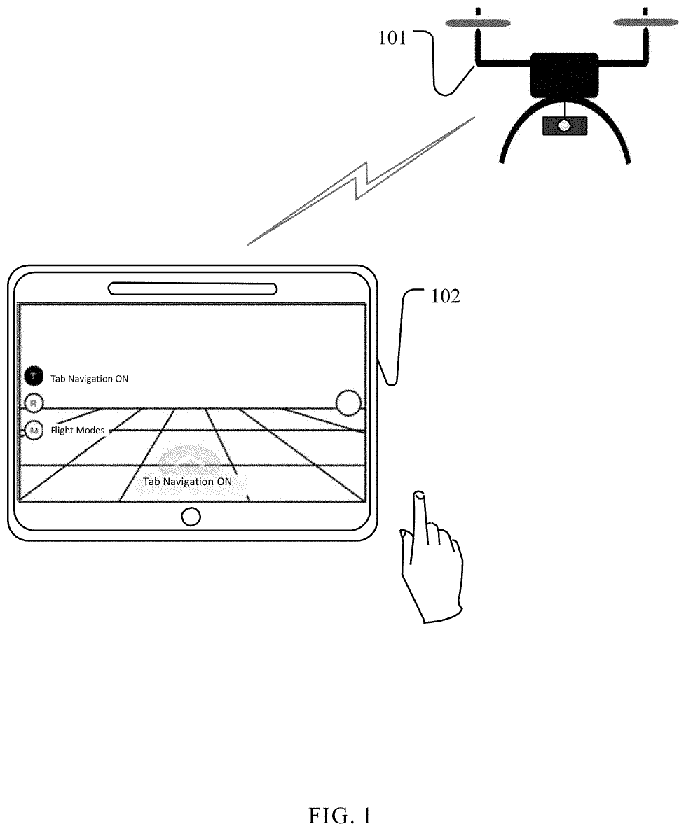

FIG. 1 is a schematic illustration of a navigation system. The navigation system may include a control device 102 and a movable object 101. FIG. 1 shows an aircraft as an example of the movable object 101. In other schematic illustrations, the movable object 101 may be movable devices, such as movable robots, unmanned vehicles, etc., which may carry an imaging device and may move based on control of a control device 102, such as a remote controller.

In some embodiments, the control device 102 may be a dedicated remote controller configured with corresponding program instructions and provided with a touch screen. In some embodiments, the control device 102 may be a smart terminal installed with a corresponding Application (“APP”), such as a smart cell phone, a tablet, a smart wearable device. In some embodiments, the control device may be a combination of two or more of a remote controller, a smart cell phone, a tablet, a smart wearable device. The aircraft may be a four-rotor or six-rotor unmanned aerial vehicle (“UAV”), or a UAV having any suitable number of rotors. In some embodiments, the aircraft may be a fixed-wing UAV. The aircraft may carry an imaging device through a gimbal, and may flexibly capture images in multiple directions. The control device 102 and the aircraft may establish a communication connection through a WiFi protocol, a software defined radio (“SDR”) protocol, or a self-defined protocol, to exchange data needed for navigation, image data, or other data.

In some embodiments, a user may use the APP installed in the control device 102, which has been connected with the aircraft, to enter the location pointing navigation mode. After takeoff of the aircraft, in a safe height range, control of the aircraft may be carried out in the location pointing navigation mode, such as when the height is in a safe height range of above 0.3 m and below 6 m, or other safe height ranges. The range may be set based on the flight task executed by the aircraft and/or the flight environment. After entering the location pointing navigation mode, the screen of the control device 102 may display images that are captured by the imaging device of the aircraft and transmitted back by the aircraft.

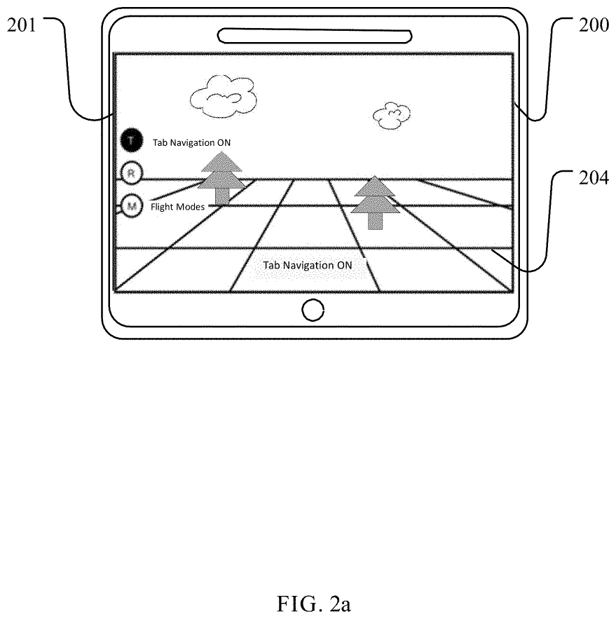

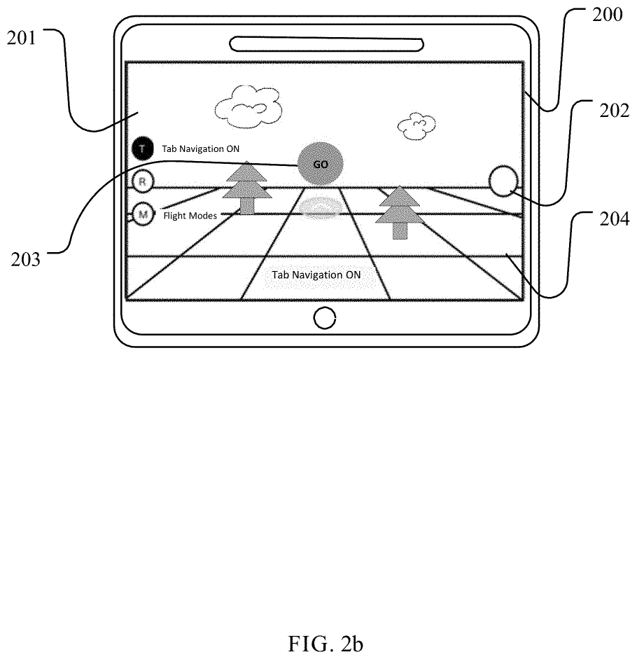

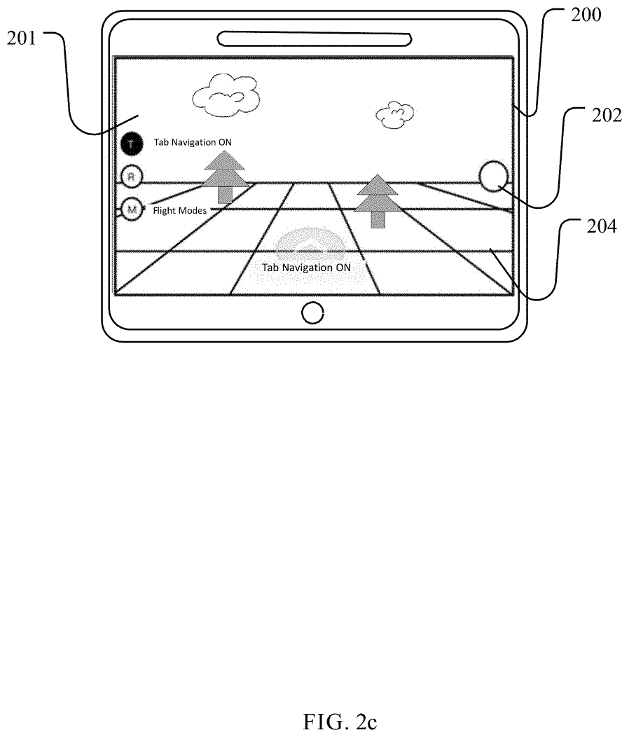

Next, the embodiments are explained through a graphical user interface 200 shown in FIG. 2a, FIG. 2b, and FIG. 2c. The control device 102 may display the graphical user interface 200. The graphical user interface 200 may display at least an image 201 captured by the imaging device, and may display a grid icon 204. In the graphical user interface, if the location pointing navigation mode has not been entered, the graphical user interface 200 may display the image captured by the imaging device. After entering the location pointing navigation mode, the graphical user interface 200 may be configured as shown in FIG. 2a. The user may click the grid icon 204 on the screen of the control device 102, i.e., click a region covered by the grid icon 204. The screen of the control device 102 may be a touch screen. The user may user an object, such as a finger, to directly click a corresponding location in the region covered by the grid icon 204. After the click operation of the user, the graphical user interface of the control device 102 may display a virtual reality circular disk 202. The virtual reality circular disk 202 may be a location icon to represent a location point clicked by the user. After determining the location point through clicking, the control device 102 may prompt a “Go” button 203. The button 203 may be a triggering icon configured to control the aircraft to start moving toward the target navigation point corresponding to the location point after receiving a click operation from the user.

In some embodiments, after the user clicks the “Go” button 203, the control device 102 may transmit a control command to the aircraft. The aircraft may execute flight control based on flight dynamics of itself to arrive at a location above the corresponding target navigation point. During the flight of the aircraft, the horizontal height of the aircraft may be maintained unchanged. During the flight of the aircraft toward the target navigation point, the aircraft may gradually approach the virtual reality circular disk 202. The image of the virtual reality circular disk 202 may be gradually enlarged in the graphical user interface to indicate that the aircraft is moving closer to the target navigation point.

In some embodiments, during the flight of the aircraft toward the target navigation point, the graphical user interface 200 may display, in real time, new images captured by the imaging device. At the graphical user interface 200, the user may continue to click other locations of the image 201 on the screen to control the flight direction of the aircraft. When the user clicks another location to change the flight direction, the aircraft may execute coordination of a turning action based on the flight dynamics of itself, such that the aircraft flies along a smooth flight path. In some embodiments, different control processes may be executed for the aircraft based on different clicking operations at the graphical user interface 200. For example, if the operation is a short single click, the flight direction of the aircraft may be controlled, such that the aircraft first flies toward a middle location point selected by the single click operation, and then continues to fly toward the target navigation point. If the operation is a long-press operation, the target navigation point may be changed. A new target navigation point may be calculated based on location information of the location point corresponding to the long-press operation in the image. The aircraft may no longer fly toward the original target navigation point.

In some embodiments, during the flight of the aircraft toward the target navigation point, autonomous obstacle avoidance may be performed based on a sensing system provided at the aircraft. When a first class of obstacle, which is relatively small, is detected in the flight direction, an obstacle avoidance flight may be executed to bypass the first class of obstacle. If a second class of obstacle, which is relatively large, is detected, then the aircraft may automatically brake and hover at a location. The user may click the left and/or right sides of the screen to execute turning of the yaw angle at the same location, until an image object corresponding to the clicked location point is located in a center region (target region) of the captured image. After the aircraft turns the yaw angle at the same location, the user may continue to operate to select a location from the region covered by the grid icon 204.

In some embodiments, the location pointing navigation mode and the direction pointing navigation mode may be switched. Various methods may be used to switch these modes. In one embodiment, when the user directly clicks a sky portion of the image 201 displayed at the graphical user interface 200 to determine a location point, only the flight direction of the aircraft may be changed based on the location information of the location point in the image. For example, in the direction pointing navigation mode, when the location point of the sky portion of the image clicked is located right above the center point of the image, the aircraft may fly upward. When the location point of the sky portion of the image clicked is located at the right upper direction of the center point of the image, the aircraft may fly in the upper right direction. When the user clicks the region covered by the grid icon 204 at the graphical user interface 200 to determine the location point, a target navigation point corresponding to the location point may be calculated, and the aircraft may be controlled to fly toward the location of the target navigation point. In some embodiments, a button may be configured and displayed at the graphical user interface 200 to allow the user to click. When the user clicks the button, the control mode of the aircraft may be in the location pointing navigation mode. The aircraft may fly and navigate based on the target navigation point. Alternatively, when the user clicks the button, the control mode of the aircraft may be in the direction pointing navigation mode, such that the aircraft may navigate by only determining a flight direction. In some embodiments, if the user clicks the graphical user interface 200 to determine a location point, a corresponding target navigation point may be calculated based on the location point, and the control mode of the aircraft may be in the location pointing navigation mode. If the corresponding target navigation point cannot be obtained through calculation based on the location point, then the control mode of the aircraft may be in the direction pointing navigation mode.

The present disclosure makes it convenient for the user to determine a target navigation point for navigating the movable object based on a captured image. The user may intuitively perform pointing navigation operations on the graphical user interface, to control the movable object to directly move toward a location where a target object may be effectively observed. The disclosed method and device increase the accuracy of executing observation tasks by the movable object, and increase the efficiency of task execution.

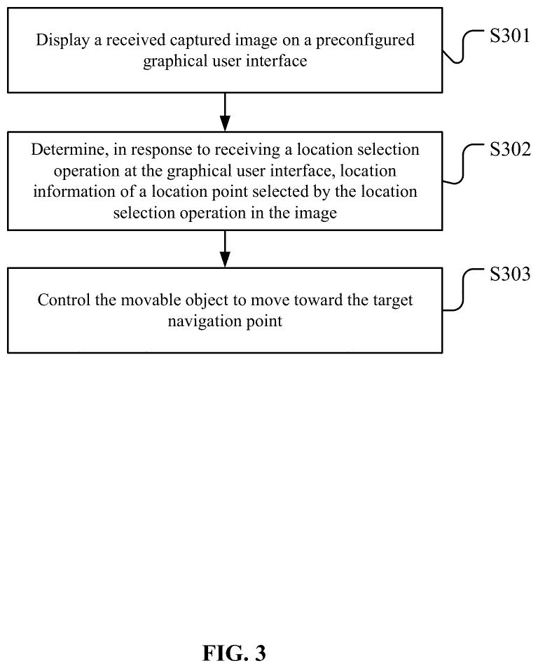

FIG. 3 is a flow chart illustrating a navigation processing method. The method may be realized through the control device described above. The method may include the following steps:

S301: displaying a received captured image on a preconfigured graphical user interface, the captured image being captured by an imaging device provided at the movable object. The graphical user interface may be an interface preconfigured to display images captured by the imaging device. The graphical user interface may detect user operations and execute corresponding processes. The detailed graphical user interface may refer to those shown in FIG. 2a, FIG. 2b, and FIG. 2c. The imaging device may be carried by the movable object through a gimbal. The imaging device and a movement controller (e.g., a flight controller of the aircraft) of the movable object may be connected through wired or wireless communication signals.

S302: determining, in response to receiving a location selection operation at the graphical user interface, location information of a location point selected by the location selection operation in the image. The location selection operation may be generated after the user clicks the graphical user interface. The location selection operation may be user operations on the graphical user interface, such as single click, double click, long-press, etc. After receiving the location selection operation, pixel location of the selected location point in the image, i.e., location information of the selected location in the image, may be determined based on a location clicked by the user on the screen.

S303: controlling the movable object to move toward the target navigation point, the target navigation point being obtained based on the location information.

In some embodiments, the control device may send the location information to the movable object, such that the movable object may move toward the target navigation point indicated by the location information. The target navigation point may be calculated by the movable object based on the location information transmitted from the control device. After receiving an operation by the user on the graphical user interface that triggers the movement of the movable object, the control device may generate a control command, and may control the movable object to move based on the calculated target navigation point. In some embodiments, after the movable object determines the target navigation point based on the location information transmitted by the control device, the movable object may directly move toward the target navigation point.

The present disclosure makes it convenient for the user to determine a location point for navigating the movable object based on a captured image. The user may intuitively perform pointing navigation operations at the graphical user interface, to control the movable object to directly move toward a location where a target object may be effectively observed. The disclosed method and device increase the accuracy of executing observation tasks by the movable object, and increase the efficiency of task execution.

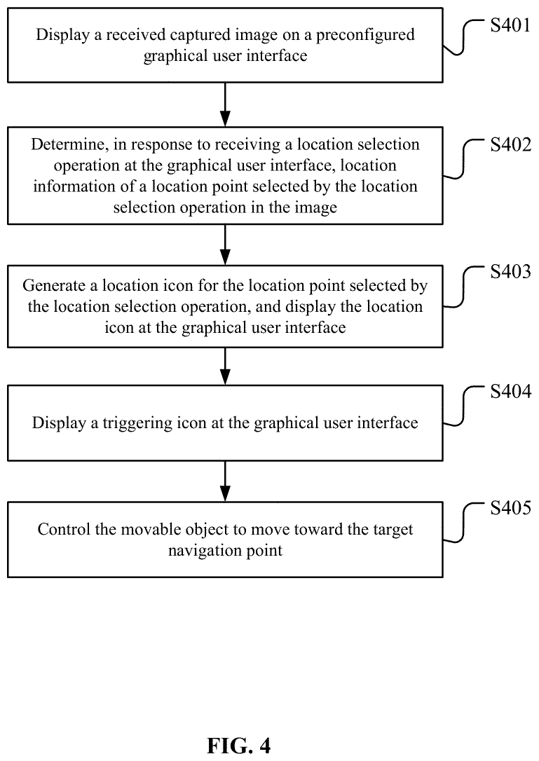

FIG. 4 is a flow chart illustrating another method for navigation processing. The method may be realized through the control device described above. The method may include the following steps:

S401: displaying a received captured image at a preconfigured graphical user interface, the captured image being captured by an imaging device provided at the movable object.

S402: determining, in response to receiving a location selection operation at the graphical user interface, location information of a location point selected by the location selection operation in the image.

In some embodiments, a grid icon may be generated at the graphical user interface. The grid icon may represent a ground. The grid icon may be generated based on at least one of an imaging angle of the imaging device (attitude of the gimbal), an FOV angle of the imaging device, or a height of the movable object. The grid icon may be displayed to cover a specified region of the captured image. A location selection operation may be detected at the specified region covered by the grid icon. The specified region may be a region corresponding to the ground portion in the image. For example, operations such as a clicking operation at the region covered by the grid icon may be treated as location selection operations. In other words, only the operations such as clicking by the user on the grid icon may be treated as location selection operations to execute subsequent steps. Otherwise, the subsequent steps such as S403 may not be executed. In some embodiments, user operations other than those on the grid icon may be used to perform other controls, such as controlling the movable object to rotate around the pitch axis of the gimbal, or only controlling the current moving direction of the movable object, such as the aircraft.

In some embodiments, user operations received in a region outside of the grid icon in the graphical user interface may be treated as direction selection operations. When receiving the direction selection operation in a region outside of the grid icon in the graphical user interface, location information of a location point selected by the direction selection operation in the image may be determined. The movable object may be controlled to move in a target moving direction. The target moving direction may be determined based on the location information of the location point selected by the direction selection operation in the image. In other words, an operation in a region outside of the grid icon, such as a click operation by the user, may be treated as an operation for controlling a moving direction of the movable object.

S403: generating a location icon for the location point selected by the location selection operation, and displaying the location icon at the graphical user interface. The location icon may be the above-mentioned virtual reality circular disk. The location icon may be pasted to the grid icon displayed at the graphical user interface. During subsequent moving process of the movable object, the size of the location icon may be adjusted based on the distance between the movable object and the target navigation point. The size of the location icon may indicate the value of the distance between the movable object and the target navigation point. In some embodiments, the closer the movable object to the target navigation point, the larger the size of the location icon.

S404: displaying a triggering icon at the graphical user interface, the triggering icon configured to indicate whether to control the movable object to move toward the target navigation point; when an operation selecting the triggering icon is received, execution of step S405 may be triggered.

S405: controlling the movable object to move toward the target navigation point, the target navigation point being obtained based on the location information. The target navigation point is a location point in the global coordinate system determined based on the location information.

In some embodiments, the movable object may be controlled to move toward the target navigation point based on predetermined operation height information. The operation height information may include: obtained current height information of the movable object, or received configured height information. The control device may transmit a control command to the aircraft after receiving a click operation of the triggering icon. The control command may carry information relating to controlling the aircraft to move based on predetermined operation height information. Alternatively, in some embodiments, when the control command does not carry any information indicating height, by default, the control device may control the aircraft to move based on predetermined operation height information, such as controlling the flight of the aircraft based on the current height of the aircraft. The configured height information may indicate a safe height configured through the graphical user interface, or a safe height preconfigured on the movable object by the user.

In some embodiments, steps for executing controlling the movable object to move toward the target navigation point may include: detecting a flight control command; if the flight control command is a first control command, then triggering the execution of S405; if the flight control command is a second control command, then controlling the movable object to move in the target moving direction. The target moving direction may be obtained based on the location information of the location point selected by the location selection operation in the image. In other words, only when the first control command is detected, step S405 may be executed to control the movable object based on the target navigation point. If the second control command is detected, then only the current moving direction of the movable object, such as the aircraft, is controlled. The flight control command may be a switch command, which may be generated when the user clicks a switch button at the graphical user interface. In some embodiments, the flight control command is a mode selection command. For example, when the user clicks a first button at the graphical user interface, a mode selection command (e.g., first control command) relating to the location pointing navigation mode may be generated. When the user clicks a second button at the graphical user interface, a mode selection command (e.g., second control command) relating to the direction selection navigation mode may be generated.

In some embodiments, after the movable object moves to a predetermined region of the target navigation point, the movable object may hover in the predetermined region in the air over the target navigation point based on the operation height information. The movable object may determine, based on a positioning module, such as a GPS module carried by the movable object, that location coordinates of the movable object in the global coordinate system are the same as the location coordinates of the target navigation point, or the movable object is within a predetermined distance range of the target navigation point, then it may be deemed that the navigation to the target navigation point has been completed. The movable object, such as the aircraft, need to hover in the predetermined region in the air over the target navigation point. The distances from various locations in the predetermined region to the coordinate location (e.g., the GPS coordinates close to the ground) of the target navigation point may be smaller than a predetermined distance value.

In some embodiments, during the moving process of the movable object, if a location update operation is detected at the graphical user interface, updated location information of the location point selected by the location update operation in the image may be determined. The movable object may be controlled to move toward the updated target navigation point. The updated navigation point may be obtained based on updated location information. The location update operation may be determined when a click operation of a region covered by a grid icon in the image displayed at the graphical user interface, a long-press operation, or other predetermined user operation, is detected. When such operation is detected, the control device may re-determine the new target navigation point based on the location point selected by the location update operation. The new target navigation point may be re-determined. The re-determined target navigation point may be the updated navigation point. In some embodiments, the updated navigation point may be calculated by the control device. In some embodiments, the updated navigation point may be calculated by the movable object based on updated location information transmitted from the control device to the movable object. After the update navigation point is determined, the movable object no longer moves toward the original target navigation point determined prior to receiving the location update operation. The control device may directly delete the original target navigation point. Alternatively, the original target navigation point may be stored for subsequent analysis of motion data of the movable object. The process of re-determining the target navigation point may refer to the above descriptions of relevant steps of determining the target navigation point in the above embodiments.

In some embodiments, during the moving process of the movable object, the movable object may automatically detect an obstacle in the flight direction, and may perform different obstacle avoidance operations for different obstacles. In some embodiments, the movable object may enter a hover state when detecting a first class of obstacle, and may execute obstacle avoidance movement when detecting a second class of obstacle. The obstacle avoidance movement may be performed to bypass the second class of obstacle while the movable object moves toward the target navigation point. The first class of obstacle may be a building, a mountain, etc., which are of a relatively larger size. A movable object such as an aircraft may not be able to quickly bypass such an obstacle. The aircraft may take a hover action, such that the user may be notified to take corresponding control operations. For other obstacles, such as a movable robot, the movable object may stop moving, such that the user may take corresponding control operations. The second class of obstacle may have a relatively smaller size. The movable object may calculate an obstacle avoidance route to bypass the obstacle, such as power line pole, small tree, etc. The user does not need to take actions for the second class of obstacle. The movable object, such as the aircraft, may calculate the obstacle avoidance route to automatically bypass the obstacle.

In some embodiments, during the moving process of the movable object, a side moving control operation at the graphical user interface may be monitored. If a side moving control operation is received, the movable object may be controlled to move to a side based on the monitored side moving control operation. The side moving control operation may include any one of: a left-to-right sliding operation at the graphical user interface, a right-to-left sliding operation at the graphical user interface, an up-to-down sliding operation at the graphical user interface, a down-to-up sliding operation at the graphical user interface, a click operation at a left half plane of the center point of the graphical user interface, a click operation at a right half plane of the center point of the graphical user interface, a click operation at an upper half plane of the center point of the graphical user interface, a click operation at a lower half plane of the center point of the graphical user interface.

In some embodiments, monitoring a side moving control operation at the graphical user interface may be triggered base on a detection that the movable object is in a hover state. Controlling the movable object to move to a side based on the monitored side moving control operation may include: controlling the movable object to move in a plane perpendicular to a flight direction of the movable object before the movable object enters the hover state based on the side moving control operation. If the movable object such as the aircraft detects the above-described first class of obstacle, the movable object may enter a hover state. The movable object such as the aircraft may notify the control device by transmitting a notification message regarding the hover state. The screen of the control device may display an image captured by the imaging device of the movable object. The user may move the movable object to a side through observation by naked eyes or test flight, such that the movable object (e.g., the aircraft) may be manually controlled to avoid the obstacle. For a movable object such as a four-rotor unmanned aerial vehicle, moving to a side may be realized through flight in the up, down, left, and right directions. This may realize the side movement.

In some embodiments, the control device may control the yaw angle of the movable object, such as the aircraft, to adjust the yaw angle of the movable object, such as the aircraft, to a certain angle. The movable object may fly forward in a direction along with the adjusted yaw angle. This may also avoid the first class of obstacle. In some embodiments, a yaw control operation may be detected at the graphical user interface. The control device may control the yaw angle of the movable object based on the yaw control operation, such that the movable object may fly based on the new yaw angle. In some embodiments, the control device may transmit a rotation control command to the movable object based on an object location point indicated by the yaw control operation detected at the graphical user interface. The rotation control command may be configured to control the movable object to rotate to the new yaw angle, such that an image object of the object location point is in a target region of an image captured by the imaging device. The control device may continuously control the yaw angle of the movable object, to cause the movable object to rotate, until in a new image captured by the imaging device, the image object of the object location point indicated by the yaw control operation of the user is in a central region of the new image. In other words, during the movement of the movable object, if the movable object encounters an obstacle that cannot be bypassed and the movable object is in a hover state, when the user initiates a yaw control operation by clicking on the graphical user interface, or when the user proactively initiate the yaw control operation by clicking on the graphical user interface, the control device may control the rotation of the movable object to change the flight direction (i.e., the yaw angle), and to continue with the movement.

In some embodiments, during the movement of the movable object, if a moving direction adjustment operation is detected at the graphical user interface, a control command may be transmitted to the movable object to control the current moving direction of the movable object. The moving direction adjustment operation may include: sliding operations or long-press operations received at the graphical user interface for controlling adjustment of the current moving direction of the movable object. In other words, the moving direction adjustment operation may be different from the location update operation described above. During the movement of the movable object, if the control device receives certain predetermined special operations configured for only adjusting the directions, the control device may control the movable object to change the current moving direction. But when a predetermined time period has elapsed after adjusting the moving direction, the aircraft may automatically adjust the flight direction to continue moving toward the target navigation point. The subsequent ultimate destination can still be the target navigation point.

In some embodiments, if the target navigation point cannot be obtained based on the location information, then the movable object may be controlled to move in a target moving direction. The target moving direction may be obtained from the location information of the location point selected by the location selection operation in the image. In other words, if an error occurred to the calculation of the target navigation point, or if the location selection operation of the user at the graphical user interface selected a sky, or if the calculated target navigation point is too far away from the movable object, the control device may treat the location selection operation as a direction control operation. The control mode of the movable object may be a direction pointing navigation mode. The moving direction of the movable object may be controlled based on the location information of the location point selected by the location selection operation in the image. For example, if the location information indicates that the location point is right above the center of the image, the movable object may be controlled to move in an upward direction. If the location information indicates that the location point is at the upper left, then the movable object may be controlled to move in an upper left direction.

In the present disclosure, the user may determine a location point based on a captured image to realize navigation for the movable object. The user may intuitively perform pointing navigation operations at the graphical user interface, such that the movable object can directly move toward a location where a target object can be effectively observed. The disclosed method and device increase the accuracy of the movable object executing relevant observation tasks, and increase the task execution efficiency. During the movement, the user may intuitively control the flight direction, yaw angle, etc., of the movable object, such that the movable object may avoid obstacles in the autonomously navigated movement. In the meantime, different user operations may be processed differently, which can satisfy user demands for automatic and intelligent control of the movable object.

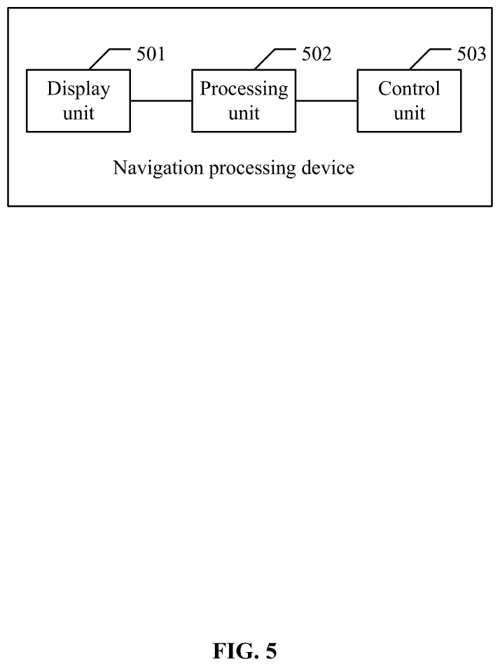

FIG. 5 is a schematic diagram of a navigation processing device. The device may be provided in a smart terminal, or in a dedicated control device for controlling a movable object such as an aircraft. The device may include the following units:

a display unit (or a display device) 501 configured to display captured images at the preconfigured graphical user interface. The captured images are captured by an imaging device provided at the movable object. The device may also include a processing unit (or a processor) 502 configured to determine, after receiving a location selection operation at the graphical user interface, location information of a location point selected by the location selection operation in the image. The device may also include a control unit (or a controller) 503 configured to control the movable object to move toward a target navigation point. The target navigation point may be obtained based on the location information.

In some embodiments, the target navigation point may be a location point in a global coordinate system determined based on the location information.

In some embodiments, the processing unit 502 may be configured to generate a location icon for the location point selected by the location selection operation, and to display the location icon at the graphical user interface.

In some embodiments, the processing unit 502 may be configured to display a triggering icon at the graphical user interface. The triggering icon may be configured to indicate whether to control the movable object to move toward the target navigation point. After receiving an operation selecting the triggering icon, an execution may be triggered to control the movable object to move toward the target navigation point.

In some embodiments, the control unit 503 may be configured to control the movable object to move toward the target navigation point based on predetermined operation height information. The operation height information may include: obtained current height information of the movable object, or received configured height information.

In some embodiments, after the movable object moves to a predetermined region of the target navigation point, the movable object may hover in the predetermined region in the air over the target navigation point based on the operation height information.

In some embodiments, the control unit 503 may be configured to adjust, during the movement of the movable object, a size of the location icon based on a distance between the movable object and the target navigation point. The size of the location icon may represent the value of the distance between the movable object and the target navigation point.

In some embodiments, the control unit 503 may be configured to determine, during the movement of the movable object, and if a location update operation of the movable object is received, updated location information of the location point updated by the location update operation in the image. The control unit 503 may control the movable object to move toward the updated navigation point. The update navigation point may be obtained based on the updated location information.

In some embodiments, the control unit 503 may be configured to control a yaw angle of the movable object based on a yaw control operation detected at the graphical user interface, such that the movable object may fly based on the new yaw angle.

In some embodiments, the control unit 503 may be configured to transmit a rotation control command to the movable object based on an object location point indicated by a yaw control operation detected at the graphical user interface. The rotation control command may be configured to control the movable object to rotate to a new yaw angle, such that an image object of the object location point in the image captured by the imaging device is in a target region.

In some embodiments, during the movement of the movable object, when the movable object detects a first class of obstacle, the movable object may in a hover state. When the movable object detects a second class of obstacle, the movable object may execute an obstacle avoidance movement. The obstacle avoidance movement may be configured to bypass the second class of obstacle during the movement toward the target navigation point.

In some embodiments, during the movement of the movable object, if a moving direction adjustment operation is detected at the graphical user interface, the control unit 503 may be configured to transmit a control command to the movable object to control the current moving direction of the movable object.

In some embodiments, the processing unit 502 may be configured to generate a grid icon, to display the grid icon to cover a specified region of the captured image, and to monitor and receive, at the specified region covered by the grid icon, a location selection operation.

In some embodiments, when a direction selection operation is received at a region outside of the grid icon at the graphical user interface, the control unit 503 may be configured to determine location information of a location point selected by the direction selection operation in the image, and control the movable object to move in a target moving direction. The target moving direction may be determined based on the location information of the location point selected based on the direction selection operation in the image.

In some embodiments, if the target navigation point cannot be obtained based on the location information, the control unit 503 may be configured to control the movable object to move in the target moving direction. The target moving direction may be obtained based on the location information of the location point selected by the location selection operation in the image.

In some embodiments, the control unit 503 may be configured to detect a flight control command. If the flight control command is a first control command, the processing unit 502 may control the movable object to move toward the target navigation point. When the flight control command is a second control command, the control unit 503 may be configured to control the movable object to move in a target moving direction. The target moving direction may be obtained based on location information of a location point selected by a location selection operation in the image.

In some embodiments, user operations at the graphical user interface mentioned in various embodiments, such as the location selection operation, the operation selecting the triggering icon, the location update operation, the yaw control operation, the moving direction adjustment operation, etc., may be preconfigured based on actual needs. For example, these operations may be preconfigured as the one or a combination of a long-press operation, a single click operation, a double click operation, etc. When preconfiguring these operations, a prerequisite is that the configurations should avoid a false processing. For example, in a simple implementation, a same user operation should not trigger two or more different processings.

Detailed implementation of the various units in the disclosed device can refer to the relevant steps of the various embodiments and the described contents, which are not repeated.

The present disclosure enables a user to determine a location point to realize navigation for the movable object based on a captured image. The user may intuitively perform pointing navigation operations at the graphical user interface, to instruct the movable object o directly move toward a location where a target object can be effectively observed. The disclosed method and device increase the accuracy of the movable object executing relevant observation tasks, and increase the task execution efficiency. During the movement, the user may intuitively control the flight direction and yaw angle of the movable object through the graphical user interface, such that the movable object can avoid obstacles during the movement process of autonomous navigation. In the meantime, different user operations may be processed differently, which can satisfy user demands for automatic and intelligent control of the movable object.

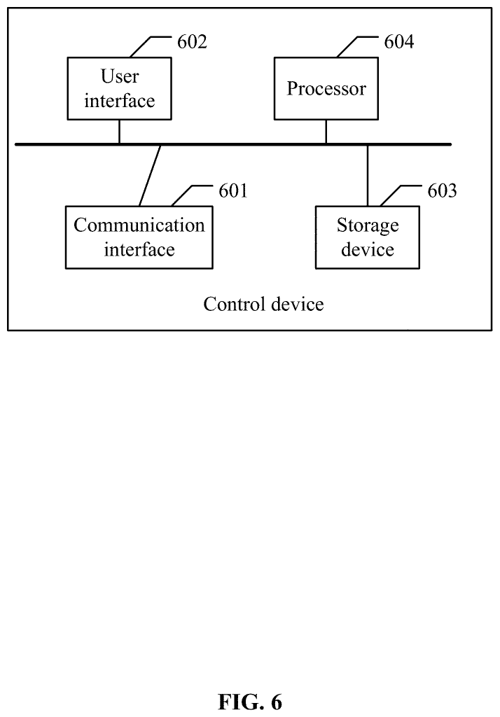

FIG. 6 is a schematic diagram of a control device. The control device may be a smart terminal having a communication capability and a display function. For example, the control device may be a smart terminal such as a smart cell phone, a tablet, etc. The control device may include a power source, physical keys, etc. The control device may include a communication interface 601, a user interface device 602, a storage device 603, and a processor 604.

In some embodiments, the user interface device 602 may include modules such as a touch screen. The user interface device 602 may be configured to display a graphical user interface, and to receive a touch screen operation by a user. The communication interface 601 may be an interface based on WiFi hotspot and/or radio frequency communication. Through the communication interface 601, the control device may exchange data with the movable object such as the aircraft, for example, to receive images captured by the imaging device carried by the movable object, to transmit a control command to the movable object, etc.

In some embodiments, the storage device 603 may include a volatile memory, such as a random-access memory (“RAM”). In some embodiments, the storage device 603 may be a non-volatile memory, such as a flash memory, a hard disk drive (“HDD”), or a solid-state drive (“SSD”). In some embodiments, the storage device 603 may include a combination of the above different types of storage devices.

In some embodiments, the processor 604 may be a central processing unit (“CPU”). In some embodiments, the processor 604 may include a hardware chip. The hardware chip may be an application-specific integrated circuit (“ASIC”), a programmable logic device (“PLD”), or a combination thereof. The PLD may be a complex programmable logic device (“CPLD”), a field-programmable gate array (“FPGA”), a generic array logic (“GAL”), or any combination thereof.

In some embodiments, the storage device 603 may be configured to store program codes or instructions. The processor 604 may retrieve and execute the program instructions to realize the various embodiments of the disclosed navigation processing methods.

In some embodiments, the storage device 603 may be configured to store program instructions. The processor 604 may be configured to retrieve and execute the program instructions stored in the storage device 603 to perform the following steps:

displaying a received captured image at a preconfigured graphical user interface, the captured image being captured by an imaging device provided at a movable object;

in response to receiving a location selection operation at the graphical user interface, determining location information of a location point selected by the location selection operation in the captured image; and

controlling the movable object to move toward a target navigation point, the target navigation point being obtained based on the location information.

In some embodiments, the target navigation point is a location point in a global coordinate system determined based on the location information.

In some embodiments, the processor 604 may retrieve and execute the program instructions stored in the storage device 603 to perform the following step:

generating a location icon for the location point selected by the location selection operation, and displaying the location icon at the graphical user interface.

In some embodiments, the processor 604 may retrieve and execute the program instructions stored in the storage device 603 to perform the following steps:

displaying a triggering icon at the graphical user interface, the triggering icon being configured to indicate whether to control the movable object to move toward the target navigation point; and

in response to receiving an operation selecting the triggering icon, triggering execution of movable object to move toward the target navigation point.

In some embodiments, when the processor 604 retrieves and executes the program instructions stored in the storage device 603 to perform the step of controlling the movable object to move toward the target navigation point, the processor 604 may perform the following step:

controlling the movable object to move toward the target navigation point based on predetermined operation height information.

The operation height information may include: obtained current height information of the movable object, or received configured height information.

In some embodiments, after the movable object moves to a predetermined region of the target navigation point, the movable object may hover in the predetermined region in the air over the target navigation point based on the operation height information.

In some embodiments, the processor 604 may be configured to retrieve and execute the program instructions stored in the storage device 603 to perform the following step:

during movement of the movable object, adjusting a size of a location icon based on a distance between the movable object and the target navigation point;

the size of the location icon may indicate a value of the distance between the movable object and the target navigation point.

In some embodiments, the processor 604 may be configured to retrieve and execute the program instructions stored in the storage device 603 to perform the following steps:

during movement of the movable object, in response to receiving a location update operation relating to the movable object, determining updated location information of an updated location point updated by the location update operation in the image; and

controlling the movable object to move toward an update navigation point, the updated navigation point being obtained based on the updated location information.

In some embodiments, the processor 604 may be configured to retrieve and execute the program instructions stored in the storage device 603 to perform the following step:

controlling, based on a yaw control operation detected at the graphical user interface, the yaw angle of the movable object, such that the movable object flies based on the new yaw angle.

In some embodiments, when the processor 604 retrieves and executes the program instructions stored in the storage device 603 to perform the step of controlling the yaw angle of the movable object based on the yaw control operation detected at the graphical user interface, the processor 604 may be configured to perform the following step:

transmitting a rotation control command to the movable object based on an object location point indicated by the yaw control operation detected at the graphical user interface.

The rotation control command may be configured to control the movable object to rotate to a new yaw angle, such that an image object of the object location point is in a target region of an image captured by the imaging device.

In some embodiments, during movement of the movable object, the movable object may be in a hover state when detecting a first class of obstacle, and may execute an obstacle avoidance movement when detecting a second class of obstacle. The obstacle avoidance movement may be configured to bypass the second class of obstacle during the process of moving toward the target navigation point.

In some embodiments, the processor 604 may be configured to retrieve and execute the program instructions stored in the storage device 603 to perform the following step:

during the movement of the movable object, in response to detecting a moving direction adjustment operation at the graphical user interface, transmitting a control command to the movable object to control a current moving direction of the movable object.

In some embodiments, the processor 604 may be configured to retrieve and execute the program instructions stored in the storage device 603 to perform the following steps:

generating a grid icon;

displaying the grid icon to cover a specified region of a captured image; and

monitoring and receiving a location selection operation in the specified region covered by the grid icon.

In some embodiments, the processor 604 may be configured to retrieve and execute the program instructions stored in the storage device 603 to perform the following steps:

in response to receiving a direction selection operation in a region outside of the grid icon at the graphical user interface, determining location information of a location point selected by the direction selection operation in an image; and

controlling the movable object to move in a target moving direction, the target moving direction being determined based on the location information of the location point selected by the direction selection operation in the image.

In some embodiments, the processor 604 may be configured to retrieve and execute the program instructions stored in the storage device 603 to perform the following step:

if the target navigation point cannot be obtained based on the location information, controlling the movable object to move in the target moving direction, the target moving direction being obtained based on the location information of the location point selected by the location selection operation.

In some embodiments, the processor 604 may be configured to retrieve and execute the program instructions stored in the storage device 603 to perform the following steps:

detecting a flight control command; and

if the flight control command is a first control command, controlling the movable object to move toward a target navigation point.

In some embodiments, the processor 604 may be configured to retrieve and execute the program instructions stored in the storage device 603 to perform the following step:

if the flight control command is a second flight control command, controlling the movable object to move in the target moving direction, the target moving direction being obtained based on the location information of the location point selected by the location selection operation in the image.

Detailed implementation of functional modules of the control device, such as the processor 604, may refer to the above contents describing relevant steps in the above embodiments, which is not repeated.

The present disclosure enables a user to determine a location point to realize navigation of the movable object based on a captured image. The user may intuitively perform pointing navigation operations at the graphical user interface, to cause the movable object to move to a location where a target object can be effectively observed. The disclosed method and device increase the accuracy of the movable object executing relevant observation tasks, and increase the task execution efficiency. During the movement, the user may intuitively control the flight direction and yaw angle of the movable object through the graphical user interface, such that the movable object can avoid obstacles during the movement process of autonomous navigation. In the meantime, different user operations may be processed differently, which can satisfy user demands for automatic and intelligent control of the movable object.

The present disclosure provides a non-transitory computer-readable storage medium configured to store a computer program. The computer program may be configured to be executed by a processor to realize the navigation processing methods of the above embodiments.

A person having ordinary skills in the art can appreciate that all or part of the above embodiments may be realized through hardware related to corresponding the computer program. The computer program may be stored in a non-transitory computer-readable medium. When the program is executed by a processor, steps of the above embodiments of the disclosed method may be performed. The storage medium may include a magnetic disk, an optical disk, a read-only memory (“ROM”), a random access memory (“RAM”), etc.

The above embodiments are only examples of the present disclosure, and do not limit the scope of the present disclosure. Although the technical solutions of the present disclosure are explained with reference to the above-described various embodiments, a person having ordinary skills in the art can understand that the various embodiments of the technical solutions may be modified, or some or all of the technical features of the various embodiments may be equivalently replaced. Such modifications or replacement do not render the spirit of the technical solutions falling out of the scope of the various embodiments of the technical solutions of the present disclosure.

What is claimed is:

1. A navigation processing method, comprising:
displaying an image at a graphical user interface, the image being obtained by an imaging device provided at a movable object;
determining, in response to receiving a location selection operation at the graphical user interface, location information of a location point selected by the location selection operation in the image; and
controlling the movable object to move toward a target navigation point, the target navigation point being obtained based on the location information.

2. The navigation processing method of claim 1, wherein the target navigation point is a location point in a global coordinate system determined based on the location information.

3. The navigation processing method of claim 1, further comprising:
generating a location icon for the location point selected by the location selection operation, and displaying the location icon at the graphical user interface.

4. The navigation processing method of claim 1, further comprising:
displaying a triggering icon at the graphical user interface, the triggering icon indicating whether to control the movable object to move toward the target navigation point; and
triggering, in response to receiving an operation selecting the triggering icon, an execution of controlling the movable object to move toward the target navigation point.

5. The navigation processing method of claim 3, further comprising:
during a movement of the movable object, adjusting a size of the location icon based on a distance between the movable object and the target navigation point,
wherein the size of the location icon indicates a value of the distance between the movable object and the target navigation point.

6. The navigation processing method of claim 1, further comprising:
controlling, based on a yaw control operation detected at the graphical user interface, a yaw angle of the movable object to cause the movable object to move based on a new yaw angle.

7. The navigation processing method of claim 6, wherein controlling the yaw angle of the movable object based on the yaw control operation detected at the graphical user interface comprises:
transmitting a rotation control command to the movable object based on an object location point indicated by the yaw control operation detected at the user interface,
wherein the rotation control command is configured to control the movable object to rotate to the new yaw angle to cause an image object of the object location point to be located in a target region of the image captured by the imaging device.

8. The navigation processing method of claim 1, further comprising:
during a movement of the movable object, transmitting, in response to detecting a moving direction adjustment operation at the graphical user interface, a control command to the movable object to control a current moving direction of the movable object.

9. The navigation processing method of claim 1, further comprising:
generating a grid icon;
displaying the grid icon to cover a specified region of the image; and
monitoring and receiving the location selection operation in the specified region covered by the grid icon.

10. The navigation processing method of claim 9, further comprising:
determining, in response to receiving a direction selection operation in a region outside of the grid icon at the graphical user interface, location information of a location point selected by the direction selection operation in the image; and
controlling the movable object to move in a target moving direction, the target moving direction being determined based on the location information of the location point selected by the direction selection operation in the image.

11. The navigation processing method of claim 1, further comprising:
controlling, based on a determination that the target navigation point cannot be determined based on the location information, the movable object to move in a target moving direction, the target moving direction being determined based on the location information of the location point selected by the location selection operation in the image.

12. The navigation processing method of claim 1, wherein controlling the movable object to move toward the target navigation point comprises:
detecting a flight control command;
if the flight control command is a first control command, controlling the movable object to move toward the target navigation point; and
if the flight control command is a second control command, controlling the movable object to move in a target moving direction, the target moving direction being obtained based on the location information of the location point selected by the location selection operation in the image.

13. A control device, comprising:
a storage device configured to store program instructions; and
a processor configured to retrieve and execute the program instructions stored in the storage device to:
display an image at a graphical user interface, the image being obtained by an imaging device provided at a movable object;
determine, in response to receiving a location selection operation at the graphical user interface, location information of a location point selected by the location selection operation in the image; and
control the movable object to move toward a target navigation point, the target navigation point being obtained based on the location information.

14. The control device of claim 13, wherein the target navigation point is a location point in a global coordinate system determined based on the location information.

15. The control device of claim 13, wherein the processor is also configured to retrieve and execute the program instructions stored in the storage device to:
generate a location icon for the location point selected by the location selection operation, and displaying the location icon at the graphical user interface.

16. The control device of claim 15, wherein the processor is also configured to retrieve and execute the program instructions stored in the storage device to:
during a movement of the movable object, adjust a size of the location icon based on a distance between the movable object and the target navigation point,
wherein the size of the location point indicates a value of the distance between the movable object and the target navigation point.

17. The control device of claim 13, wherein the processor is also configured to retrieve and execute the program instructions stored in the storage device to:
generate a grid icon;
display the grid icon to cover a specified region of the image; and
monitor and receive the location selection operation in the specified region covered by the grid icon.

18. The control device of claim 17, wherein the processor is also configured to retrieve and execute the program instructions stored in the storage device to:
determine, in response to receiving a direction selection operation in a region outside of the grid icon at the graphical user interface, location information of a location point selected by the direction selection operation in the image; and
control the movable object to move in a target moving direction, the target moving direction being determined based on the location information of the location point selected by the direction selection operation in the image.

19. The control device of claim 13, wherein the processor is also configured to retrieve and execute the program instructions stored in the storage device to:
control, based on a determination that the target navigation point cannot be determined based on the location information, the movable object to move in a target moving direction, the target moving direction being determined based on the location information of the location point selected by the location selection operation in the image.

20. The control device of claim 13, wherein when the processor retrieves and executes the program instructions to control the movable object to move toward the target navigation point, the processor is configured to:
detect a flight control command;
if the flight control command is a first control command, control the movable object to move toward the target navigation point; and
if the flight control command is a second control command, control the movable object to move in a target moving direction, the target moving direction being obtained based on the location information of the location point selected by the location selection operation in the image.
